(19) United States
(12) Patent Application Publication
(10) Pub. No.: US 2026/0241864 A1
(43) Pub. Date: Aug. 20, 2026

(54) INDIRECT VISION SYSTEM AND VEHICLE WITH THE INDIRECT VISION SYSTEM

(71) Applicant: MEKRA Lang GmbH & Co. KG, Ergersheim (DE)

(72) Inventor: Andreas Enz, Burgbernheim (DE)

(21) Appl. No.: 19/462,556

(22) Filed: Jan. 28, 2026

(30) Foreign Application Priority Data
Jan. 31, 2025 (DE) 10 2025 103 622.5

(51) Int. Cl. B60R 1/25; B60R 1/26; B60R 11/04

(52) U.S. Cl. CPC B60R 1/25; B60R 1/26; B60R 11/04; B60R 2300/50; B60R 2300/60; B60R 2300/802

(57) ABSTRACT

The present disclosure relates to an indirect vision system for a vehicle, wherein the indirect vision system comprises: an image acquisition unit having a single image sensor and an objective, which is designed and is mounted or is to be mounted on the vehicle in such a way that a plurality of predetermined areas in the vicinity of the vehicle can be captured by the image sensor in an output image, wherein the objective and the image sensor are arranged relative to each other such that a Center of the objective and a center of the image sensor are offset relative to each other, a processing unit configured to transform the output image into a transformation image, and a display unit configured to display at least a section of the transformation image. The processing unit is designed to divide the output image at least partially into output image areas according to an output grid and to transform the output image areas into transformation image areas defined by a transformation grid. The transformation grid is designed such that the specified areas can be displayed in the section of the transformation image displayed on the display unit according to a respective specification.

### CROSS-REFERENCE TO RELATED APPLICATIONS

This application claims the benefit of German Patent Application No. DE 10 2025 103 622.5, filed 31 Jan. 2025, the disclosure of which is incorporated, in its entirety, by this reference.

### TECHNICAL FIELD

The present disclosure relates to an indirect vision system for a vehicle, the indirect vision system being used in particular as a mirror replacement system. The present disclosure further relates to a vehicle with the indirect vision system.

### BACKGROUND

An indirect vision system for vehicles is known from EP 2 765 031 B1. The indirect vision system disclosed therein comprises an image acquisition unit mounted on a vehicle, a computing unit connected to the image acquisition unit, and a display unit connected to the computing unit. The image acquisition unit comprises an objective with an optical axis and a digital image detection unit, wherein the image acquisition unit being mounted on the vehicle such that it captures at least part of a first field of view required by law and at least part of a second field of view required by law on one side of the vehicle. The objective is arranged with its optical axis eccentric to a central point of the digital image acquisition unit.

DE 10 2014 006 153 A1 also discloses a method for displaying an image of an indirect field of view in the vicinity of a vehicle.

Furthermore, DE 10 2014 006 150 B4 discloses a method for displaying different indirect fields of view of a vehicle.

### SUMMARY

The object of the present disclosure is to provide a technique that makes it possible to display plural areas in a vehicle's environment without any transition, i.e., without stitching edge or area boundary.

This object is solved by the indirect vision system as well as the vehicle with the features according to the independent claims. Advantageous embodiments are subject of the dependent claims.

An indirect vision system according to the disclosure is used in particular for a vehicle. The vehicle is in particular a vehicle according to EU vehicle class N. The vehicle may also be a commercial vehicle, such as a truck, transporter, van, pick-up, refrigerator truck, dump truck, tractor truck, dumper, tanker, car transporter, tow truck, garbage truck, delivery truck, construction site vehicle, truck crane, truck mixer, breakdown vehicle, tractor, street cleaner, fire truck, ambulance, articulated bus, public bus, or a coach.

The indirect vision system comprises an image acquisition unit that has a single image sensor and an objective and is designed and mounted to the vehicle in such a way that several predetermined areas in the vicinity of the vehicle can be captured by the image sensor in an original image. The plurality of areas may overlap or be separated from each other, for example, adjacent or spaced apart from each other.

To form the image acquisition unit, the image sensor and the objective can be accommodated in a common housing. The housing can form a device for attachment to a vehicle body. The housing may also be formed by a vehicle body component. The image acquisition unit can be mounted in the area of an A-pillar on an upper edge of the vehicle at a height of approximately 2 to 3.5 m. Moreover, the vehicle can have several indirect vision systems, for example on a driver's side and on a passenger side of the vehicle. It is also conceivable that the indirect vision system is installed in the interior of the vehicle and captures an area behind the vehicle, similar to a rearview mirror. The indirect vision system can be installed on the vehicle in addition to a play system or as an alternative to it, i.e., as a mirror replacement system.

The objective may have several lenses. Advantageously, the objective has a fixed aperture angle, i.e., it is not a zoom objective, but a fixed focal length objective. In addition, the alignment of the objective is rigid, i.e., the alignment can only be changed by readjusting the housing on the vehicle. Furthermore, the objective can be a wide-angle objective, a super wide-angle objective, or a fisheye objective. Preferably, the image sensor and the objective achieve an aperture angle of 160° to 220°, or even more preferably 180° to 200°.

The objective and the image sensor are arranged in such a way that the central point of the objective and the central point of the image sensor are offset from each other. This means that an objective axis running through the central point of the objective runs eccentrically through the image sensor. The objective axis and a surface normal of the image sensor can be parallel to each other. However, it is also conceivable that the objective axis and the surface normal of the image sensor are not parallel. In this way, the area on the image sensor that is imaged by the center of the objective is captured with little distortion.

The indirect vision system also comprises a processing unit that is designed to transform the output image into a transformation image. This means that the processing unit performs an image transformation. The processing unit can be a microcomputer that performs the image transformation by executing a corresponding computer program. The processing unit can be located in the housing of the image acquisition unit or separately from it. However, the processing unit may also be arranged in the immediate vicinity of a display unit described below or may be formed by the latter.

Furthermore, the indirect vision system comprises a display unit that is designed to display at least a section of the transformation image. This means that the display unit can be an optical display unit, such as a display. The display unit can have a touch input function. The display unit may be provided specifically for the indirect vision system. Alternatively, the display unit may also be formed by an optical display unit installed in an interior space of the vehicle, for example, in a center console. The section of the transformation image may be displayed over the entire surface or in a predetermined area of the display unit. The section of the transformation image is displayed in accordance with the aspect ratio of the display unit or the specified area of the display unit. The displayed section of the transformation image can also be changed manually by the driver, e.g., using a provided adjustment knob. In addition, the displayed section of the transformation image can be changed automatically while the vehicle is in motion, for example when cornering. For example, the displayed section of the transformation image can be changed automatically so that a larger area in the direction of the curve can be displayed or is displayed. When changes are made to the displayed section of the transformation image, it may even happen that a point imaged by the Center of the objective is not displayed on the display unit. It is also conceivable that the manual change of the portion during travel at a predetermined speed or higher is switched back to a standard display in which the multiple areas are, for example, each displayed in full again.

The processing unit is designed to divide the output image at least partially into output image areas according to an output grid. This means that the processing unit superimposes the output grid on the output image in order to obtain the output image areas. Moreover, the processing unit is configured to transform the output image areas into transformation image areas defined by a transformation grid. The transformation grid is configured in such a way that the specified areas can be displayed or are displayed in the portion of the transformation image shown on the display unit in accordance with a respective specification. The specification for the individual areas may comprise a size and/or a sharpness and/or a magnification factor and/or a distortion and/or completeness. The transformation grid may be defined in advance.

This advance definition may be carried out in particular on the basis of reference images and/or simulations. By transforming the output image acquired by the image acquisition unit with the single image sensor in this way, the multiple areas around the vehicle can be displayed without transition in a single display, i.e., without stitching edges or area boundaries. This makes it easier for a driver to control the vehicle using the indirect vision system, such as when reversing the vehicle. It should be noted that the transformation using the output grid and the transformation grid does not correspond to lens correction for distortion-free display of the portion of the transformation image on the display unit. Nevertheless, lens correction can also be performed when determining the transformation grid.

The output grid and the transformation grid can have edges and nodes corresponding to each other that act as support points for the output image areas and the transformation image areas, respectively. This means that the output grid and the transformation grid have the same number of edges and nodes. Thus, the same number of areas is obtained in the output image and the transformation image, and the areas are defined by the corresponding nodes or edges. In the transformation grid, some of the edges and/or nodes may be changed compared to the initial grid. As a result, the shape of a transformation area may differ from that of its corresponding output image area. The processing unit can be designed to transform the output image areas supported by the edges and/or nodes changed in the transformation grid compared to the initial grid into the transformation image areas by means of interpolation. Accordingly, the processing unit can be designed to perform a network transformation in order to transform the output image into the transformation image.

In doing so, the course or shape and/or position of the edges and/or the position of the nodes in the transformation grid may be changed relative to the initial grid. In particular, the courses and/or positions of the edges and/or the position of the nodes in the transformation grid are changed relative to the initial grid in such a way that a continuous transition between the output image areas defined thereby is maintained. By adjusting the edges and nodes, the areas defined between them can be compressed, stretched, curved, straightened, reduced, enlarged, and/or distorted.

Furthermore, the processing unit can be designed to adjust the output grid and/or the transformation grid. Adjustment of the output grid and/or the transformation grid can be carried out dynamically in particular. In the case of a dynamic adjustment, the processing unit uses several output grids and/or several transformation grids in sequence when transforming the output image into the transformation image. The output grid and/or the transformation grid can be adapted to take into account a change in a respective specification of the multiple areas. The respective specification of the multiple areas may change according to a driving situation.

The processing unit may be designed to adjust the output grid and/or the transformation grid during automatic or manual adjustment of the portion of the transformation image displayed on the display unit and/or during a view change on the display unit. As already described above, a portion of the transformation image displayed on the display unit can be changed manually, for example by a driver, or automatically when cornering. It is also conceivable that the display unit could switch from a full-screen display of the portion of the transformation image to a partial display of the portion of the transformation image with a different aspect ratio. In particular, the output grid and/or the transformation grid are adjusted dynamically. This means that during manual/automatic change of the displayed portion of the transformation image or during a view change, the processing unit uses several output grids and/or transformation grids in sequence. This ensures that the multiple areas around the vehicle are displayed according to their respective specifications even after or during a change to the displayed portion of the transformation image or a view change.

It is advantageous if the Center of the objective is shifted toward the vehicle in relation to the center of the image sensor. This is because the image sensor in an indirect vision system is often positioned in such a way that it only images a small edge area of one side of the vehicle. If the Center of the objective and the center of the image sensor were to coincide, the side of the vehicle would be displayed with significant distortion due to the comparatively large aperture angle. However, by shifting the Center of the objective toward the vehicle, the vehicle side is imaged on the image sensor with no or at least comparatively little distortion.

The Center of the objective can image a point that is within a distance of up to 1.5 m from one side of the vehicle. The imaged point is located in particular on a ground surface next to the vehicle. In this way, several areas around the vehicle that are necessary for safe driving are imaged on the image sensor.

The transformation grid can be designed such that an edge of the vehicle used as a vehicle reference is represented in the transformation image as a substantially straight line. The edge serves as an orientation aid for the driver of the vehicle when maneuvering the vehicle, such as when reversing, and the straight display makes it easier and therefore safer for the driver to maneuver the vehicle. The edge used as a vehicle reference can be a lateral lower edge of the vehicle. The edge used can extend over several vehicle components, such as a tractor and a trailer when aligned straight with each other.

In addition, the transformation grid can be designed in such a way that a lateral extension of a front edge of the vehicle is displayed as a straight line in the transformation image. The lateral extension is, in particular, an imaginary continuation of the front edge. The straight display of this lateral extension gives the driver a better understanding of the multiple areas around the vehicle and thus enables safe driving of the vehicle.

The multiple areas may comprise at least one area extending from a front edge of the vehicle to a horizon behind the vehicle at a predetermined distance beside the vehicle. The predetermined distance may be 1.5 m. This area may be completely contained within the portion of the transformation image displayed on the display unit. This means that the portion of the transformation image cannot be changed in such a way that this area is not displayed on the display unit. The area described above represents a safety-relevant area when driving a vehicle, and the complete display of the area on the display unit thus increases safety when driving, in particular when reversing the vehicle.

The vehicle may include a trailer. The vehicle is in particular a truck. In this case, the portion of the transformation image displayed on the display unit may include a front upper corner of the trailer. The front upper corner of the trailer is an important reference point for a driver when reversing, so that this display increases safety when reversing the vehicle, in particular the truck with trailer.

The multiple areas may comprise the legal fields of vision II and IV in accordance with UN/ECE-R46 (Revision 7, Amendment 2). Preferably, the multiple areas may also comprise the legal field of view V in accordance with UN/ECE-R46 (Revision 7, Amendment 2). Even more preferably, the multiple areas may also include a larger field of view in accordance with UN/ECE-R46 (Revision 7, Amendment 2).

A legal field of view in accordance with Class II on the driver's side must be such that the driver can see at least a 5 m wide, flat and horizontal part of the roadway, bounded by a plane parallel to the vertical longitudinal center plane and passing through the outermost point of the vehicle on the driver's side, extending from 30 m behind the driver's eye points to the horizon. Moreover, the roadway must be visible to the driver over a width of 1 m, bounded by a plane parallel to the vertical longitudinal center plane and passing through a point 4 m behind the vertical plane that passes through the driver's eye points and through the outermost point of the vehicle.

A Class II legal field of view on the passenger side must be such that the driver can see at least a 5 m wide, flat and horizontal part of the roadway, which is bounded on the passenger side by a plane parallel to the vertical longitudinal center plane of the vehicle and passing through the outermost point on the driver's side of the vehicle, extending from the horizon to 30 m behind the driver's eye points. In addition, the road must be visible to the driver over a width of 1 m, bounded by a plane parallel to the vertical longitudinal center plane of the vehicle and passing through the outermost point of the vehicle, starting from a point 4 m behind the vertical plane passing through the driver's eye points.

A legal field of view in accordance with Class IV on the driver's side must be such that the driver can see at least a 15 m wide, flat and horizontal part of the roadway, bounded by a plane parallel to the vertical longitudinal center plane of the vehicle and passing through the outermost point on the driver's side of the vehicle, extending from at least 10 m to 25 m behind the driver's eye points. In addition, the driver must be able to see the road for a width of 4.5 m, bounded by a plane parallel to the vertical longitudinal center plane of the vehicle and passing through the outermost point of the vehicle, starting from a point 1.5 m behind the vertical plane passing through the driver's eye points.

A Class IV legal field of view on the passenger side must be such that the driver can see at least a 15 m wide, flat and horizontal part of the roadway, bounded by a plane parallel to the vertical longitudinal center plane of the vehicle and passing through the outermost point on the passenger side of the vehicle, extending from at least 10 m to 25 m behind the driver's eye points. In addition, the driver must be able to see the road for a width of 4.5 m, bounded by a plane parallel to the vertical longitudinal center plane of the vehicle and passing through the outermost point of the vehicle, starting from a point 1.5 m behind the vertical plane passing through the driver's eye points.

A Class V field of view in accordance with UN/ECE-R46 must only be monitored on the passenger side and must be such that the driver can see a flat and horizontal part of the road to the side of the vehicle, which is bounded by the following vertical planes: A plane parallel to the vertical longitudinal center plane of the vehicle and passing through the outermost point of the vehicle cabin on the passenger side. In the transverse direction, by a parallel plane passing at a distance of 2 m in front of the aforementioned plane. In the rearward direction, by a plane parallel to the vertical plane passing through the driver's eye points and located 1.75 m behind this plane. In the forward direction, by a plane parallel to the vertical plane passing through the driver's eye points and located 1 m in front of this plane. If the vertical transverse plane passing through the front edge of the vehicle's bumper is less than 1 m in front of the vertical plane passing through the driver's eye points, the field of view must be limited to this plane.

However, a Class V field of view by analogy may also be displayed on the driver's side in a mirrored manner.

If the image acquisition unit is mounted above a height of 2.4 m, only a larger field of view on the passenger side needs to be monitored, which must also be designed in such a way that the driver can see a flat and horizontal portion of the road to the side of the vehicle that is outside the field of view V, but within the limited field bounded by the following vertical planes: In the transverse direction, by the parallel plane at a distance of 4.5 m in front of the plane passing through the outermost point of the vehicle cabin on the passenger side. In the rearward direction, by a plane parallel to the plane passing through the driver's eye points and located 1.75 m behind this plane. In the forward direction, by a plane parallel to a vertical plane passing through the driver's eye points and located 3 m in front of this plane. The front of this enlarged field of view may be rounded with a radius of 2,000 mm.

In this case, the transformation grid can be designed in such a way that the legal fields of vision II and IV according to UN/ECE-R46 can be displayed or are displayed on the display unit in accordance with the respective legal requirements. Preferably, the transformation grid can also be designed in such a way that it displays the legal field of view V in accordance with the respective legal requirements according to UN/ECE-R46.

Even more preferably, the transformation grid may also be designed such that it displays the enlarged field of view in accordance with a respective legal requirement under UN/ECE-R46.

Selected requirements from UN/ECE-R46 are specified below. Further requirements may be adopted from UN/ECE-R46 (status: Revision 7, Amendment 2).

A minimum magnification factor must not be less than:
for Class II (driver's side): 0.26;
for Class IV (driver's side): 0.054;
for Class II (passenger side): 0.13;
for Class IV (passenger side): 0.016.

The average magnification factor must not be less than:
for Class II (driver's side): 0.31;
for Class IV (driver's side): 0.091;
for Class II (passenger side): 0.16;
for Class IV (passenger side): 0.046.

In the required field of view, the difference between the average magnification factor for the horizontal and vertical directions must satisfy the following equations.

The following permissible range applies to field of view II:

$$- 0.42 \leq 1 - \frac{{M}_{system / hor / avg}}{{M}_{system / ver / avg}} \leq 0.3$$

No restriction on the magnification factor is required for Class IV devices.

In addition, the aforementioned fields of view II and IV, and preferably field of view V and even more preferably the enlarged field of view, should be displayed completely on the display unit.

It is also preferable for field of view II to be displayed without distortion.

The edges and nodes of the output mesh may be arranged such that the output grid forms meshes of different sizes and/or shapes. Consequently, the output grid can already be defined with regard to a transformation to be performed for the output image areas, so that the plural areas around the vehicle are displayed according to their respective specifications.

In particular, the size and/or shape of the meshes of the output grid can be determined according to the strength of the transformation to be performed on the output image into the transformation image. In particular, the meshes can be finer in areas of the output image where a stronger transformation is to be performed, thus enabling more precise adjustment. In areas of the original image where only a weaker transformation is to be performed, the meshes can be defined more coarsely, thereby reducing the computing effort in the processing unit.

A vehicle according to the disclosure has the indirect vision system described above. The vehicle can be a vehicle of EU vehicle class N or a commercial vehicle. The vehicle can include a trailer.

### BRIEF DESCRIPTION OF THE DRAWINGS

Embodiments of the present disclosure are described below with reference to the accompanying figures, of which

FIG. 1 shows a schematic structure of the indirect vision system according to the disclosure,

FIG. 2 shows a top view of a truck with a trailer, around which several exemplary areas are shown;

FIG. 3 shows an exemplary output image captured by an image sensor;

FIG. 4 shows a subdivision of the exemplary output image into output image areas according to an output grid and a transformation of the output image areas into transformation image areas, which are defined according to a transformation grid;

FIGS. 5A to 5C show a schematic view of untransformed transformation image areas and two examples of transformed transformation image areas;

FIG. 5D to 5F show image contents obtained in accordance with the transformation image areas from FIGS. 5A to 5C;

FIG. 6 shows a subdivision of an output image into output image areas in accordance with an exemplary output grid;

FIG. 7 shows a subdivision of the output image into output image areas in accordance with a further exemplary output grid;

FIG. 8 shows a subdivision of the output image into output image regions according to another exemplary output grid;

FIG. 9 shows an exemplary output image in which a lower side edge used as a reference and an extension of a front edge are distorted;

FIG. 10 shows a transformation image obtained by transforming the exemplary output image, in which the side edge used as a reference and the extension of the front edge are displayed as straight lines;

FIG. 11 and FIG. 12 show exemplary output images imaged by an image sensor, wherein a Center of the objective is shifted so as to image a point located within a range of 1.5 m to the side of a vehicle edge,

FIG. 13 shows a transformation of an output image into a transformation image using an output grid with meshes of different sizes, with legal fields of view II, IV, and V shown in accordance with UN/ECE-R46.

### DETAILED DESCRIPTION

The following is a description of exemplary embodiments with reference to the figures. In the figures, the same reference numerals are assigned to the same or corresponding elements. It should be noted that the description of the exemplary embodiments is not intended to limit the scope of protection of the present disclosure.

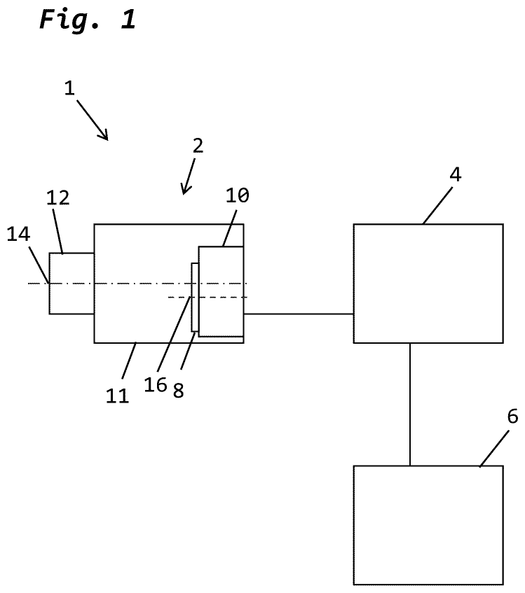

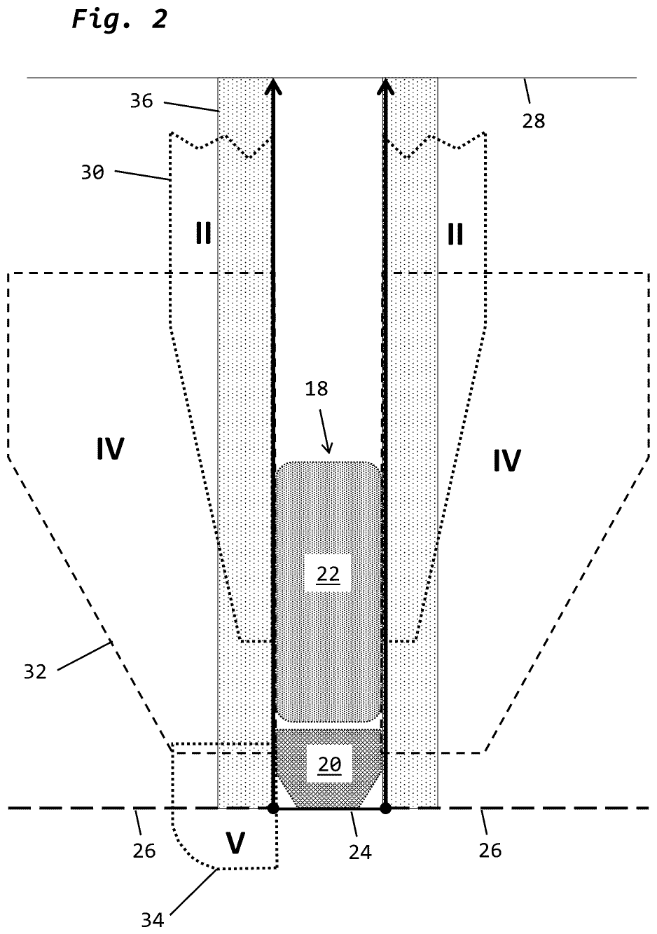

FIG. 1 shows an indirect vision system 1 that can be used for a vehicle 18 (see FIG. 2). The indirect vision system 1 has an image acquisition unit 2, a processing unit 4, and a display unit 6. The image acquisition unit 2 is connected to the processing unit 4 by cable or wirelessly for data exchange. Furthermore, the processing unit 4 is connected to the display unit 6 by wire or wirelessly for data exchange.

The image acquisition unit 2 has an image sensor 8 that is mounted on a holding device 10. The image sensor 8 and the holding device 10, which may comprise a circuit board, are accommodated in a housing 11 that can be mounted or is mounted on the outside of the vehicle 18, in particular at the height of an A-pillar of the vehicle 18 at a height of approximately 2 to 3.5 m. The housing 11 also accommodates an objective 12, which has several lenses for imaging the surroundings around the vehicle 18 on the image sensor 8. The objective 12 has a center 14. The image sensor 8 also has a center 16. However, as indicated by the two lines in FIG. 1, the two centers 14, 16 are not congruent, but are offset from each other. In other words, the objective 12 and the image sensor 8 are arranged eccentrically to each other. The eccentric arrangement is larger than a possible manufacturing tolerance.

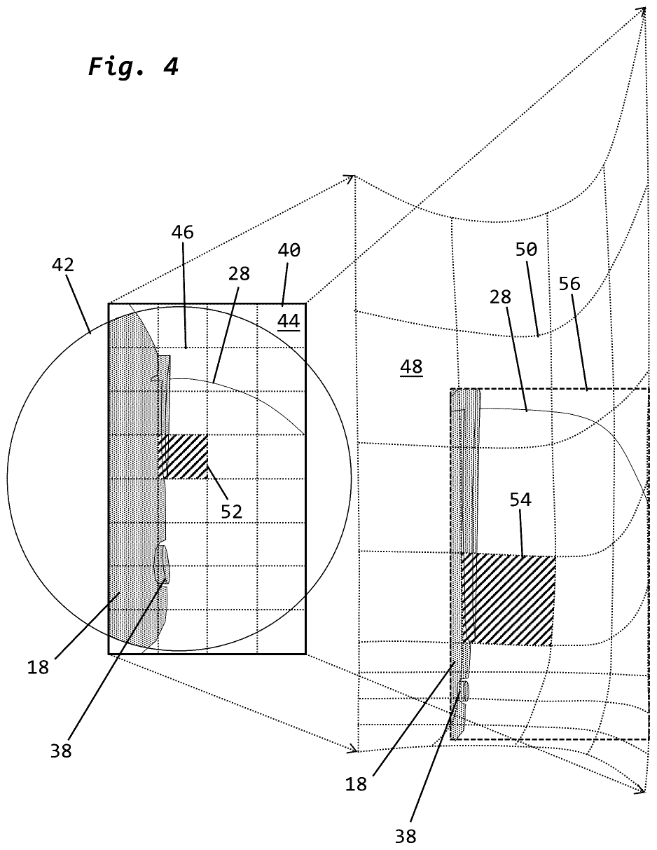

The processing unit 4 is designed to receive an image of the surroundings around the vehicle acquired by the image acquisition unit 2 as an output image 44 (see FIG. 4) and to transform the output image 44 to obtain a transformation image 48 (see FIG. 4). For this purpose, the processing unit 4 has a memory in which a computer program is stored and at least one CPU for executing the computer program stored in the memory. Consequently, the output image 44 is transformed into the transformation image 48 by executing the computer program. In addition, data of at least one output grid 46 (see FIG. 4) and at least one transformation grid (see FIG. 4), which will be described in detail later, are stored in the memory. The processing unit 4 can be located in the immediate vicinity of the image acquisition unit 2. For example, the processing unit 4 can be located in the housing 11 of the image acquisition unit 2. Alternatively, the processing unit 4 can also be located in its own housing (not shown) in an interior space of the vehicle 18.

The display unit 6 is designed to display at least a section 56 (see FIG. 4) of the transformation image 48, which it receives from the processing unit 4 for this purpose. The display unit 6 thus corresponds to an optical output unit, such as a display. The display unit 6 can be located inside the vehicle 18 on an A-pillar, for example in the area where the image acquisition unit 2 is mounted on the outside of the vehicle 18.

Alternatively, an optical output unit already present in the vehicle 18 can also serve as the display unit 6. The display unit 6 can display the section 56 of the transformation image 48 over its entire surface. Alternatively, it is also conceivable that only one area of the display unit 6 is used to output the section 56 of the transformation image 48. Furthermore, it is also possible for a driver, for example, to switch between a full-screen display and a display of section 56 of the transformation image 48 limited to a specific area. In addition, the display unit 6 may also have a touch input function.

FIG. 2 shows several areas in an environment surrounding a vehicle 18. In the example shown in FIG. 2, the vehicle 18 is a truck comprising a tractor unit 20 and a trailer 22, which are aligned in a straight line with each other. In addition, a front edge 24 of the vehicle 18 and an extension 26 of the front edge 24 on both sides of the vehicle 18 are shown. Behind the vehicle 18, a horizon line 28 is shown as a solid line. These lines are used for a subsequent description of the output image 44 and the transformation image 48.

Furthermore, a field of view II 30 and a field of view IV according to UN/ECE-R 46 are shown on both sides of the vehicle 18. In addition, a field of view V 34 according to UN/ECE-R 46 is shown on a passenger side of the vehicle 18. It should be noted that the field of view V 34 can also be monitored on a driver side of the vehicle 18.

Furthermore, an area 36 is shown which extends from the extension 26 of the front edge 24 to the horizon line 28 at a predetermined distance next to the vehicle. The predetermined distance may be 1.5 m in particular. These described areas are of great importance for the safe driving of the vehicle 18.

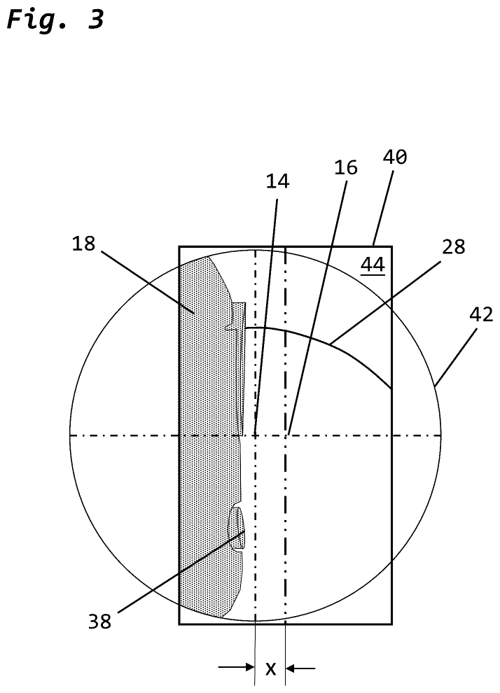

FIG. 3 shows an image of vehicle 18, in which a front wheel 38 is to be seen, on an imaginary image sensor surface 40. In addition, an objective surface 42 is shown.

The image reproduced on the image sensor surface 40 is referred to below as the output image 44. As can be seen in FIG. 3, the center 14 of the objective 12 is shifted in the horizontal direction by a distance x toward the vehicle 18 relative to the center 16 of the image sensor 8. Since the center 14 is shifted toward the vehicle 18, a lateral lower edge of the vehicle 18, which is used as a vehicle reference and also extends over the trailer 22 of the vehicle 18, can be imaged with less distortion than would be the case if the centers 14, 16 were congruent. Furthermore, the horizon line 28 is shown, which is imaged with greater curvature due to a greater distance from the center 14.

On the left, FIG. 4 shows the output image 44 displayed on the image sensor surface 40. After the output image 44 has been received by the processing unit 4, the processing unit 4 superimposes an output grid 46 on the output image 44 in order to divide the output image 44 into output image areas. After the processing unit 4 has divided the output image 44 into the output image areas, it transforms the output image areas into transformation image areas defined by a transformation grid 50. As can be seen in FIG. 4, the output grid 46 and the transformation grid 50 have the same number of meshes defined by edges and nodes. The edges and nodes act as support points for the areas defined by them. However, compared to the output grid 46, the edges and nodes in the transformation grid 50 are changed, and when transforming the output image areas into the transformation areas, the processing unit 4 performs an interpolation of the output image areas to obtain the transformation image areas. As an example, the output image area 52 is shown hatched in FIG. 4. This is transformed into the transformation image area 54 when the output image 44 is transformed into the transformation image 48. It is to be seen that the nodes of the transformation image area 54 are further apart than the nodes of the output image area 52. Accordingly, the image content present in the transformation image area 54 is displayed enlarged.

Furthermore, distortion correction takes place in an area adjacent to the vehicle 18, so that the horizon line 28 is initially displayed straight in sections in the transformation image 48. However, in an outer area of the transformation image 48, strength distortion occurs, so that the horizon line 28 bends more sharply. Since the transformation image 48 is significantly larger than the output image 44, as shown in FIG. 4, only a section 56 of the transformation image 48 is displayed on the display unit 6.

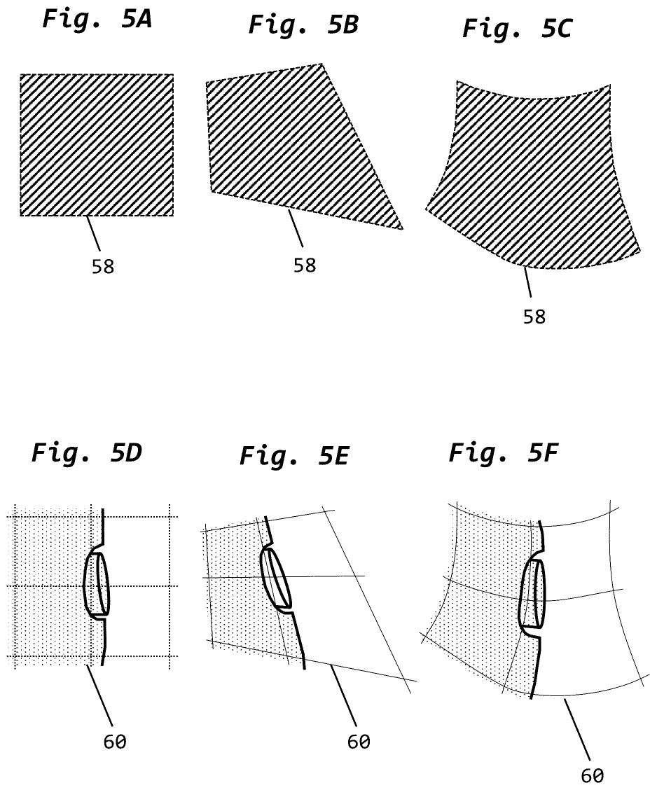

FIG. 5A shows a schematic view of untransformed transformation image areas 58. FIG. 5B shows a first example of transformed transformation image areas 58, with only the position of the nodes and edges having been changed. In the example of transformed transformation image areas 58 shown in FIG. 5B, the course of the edges has also been changed. This results in the image contents shown in FIGS. 5D to 5F. FIG. 5D shows the image content as captured by the image sensor. However, if the transformation image areas 58 are enlarged in size compared to the corresponding output image areas, the image content 60 is displayed enlarged. Changing the position of the edges and nodes results in the image content 60 shown in FIG. 5E. It can be seen that the shape of the displayed image content 60 changes in accordance with the change in the position of the edges and nodes. Furthermore, a course of edges in the image content 60 can also be changed in accordance with a course of the edges of the associated transformation image area 58. By changing the position of the edges and nodes and adjusting the course of the edges, the image content can thus be suitably adjusted during the transformation of the output image 44 into the transformation image 48.

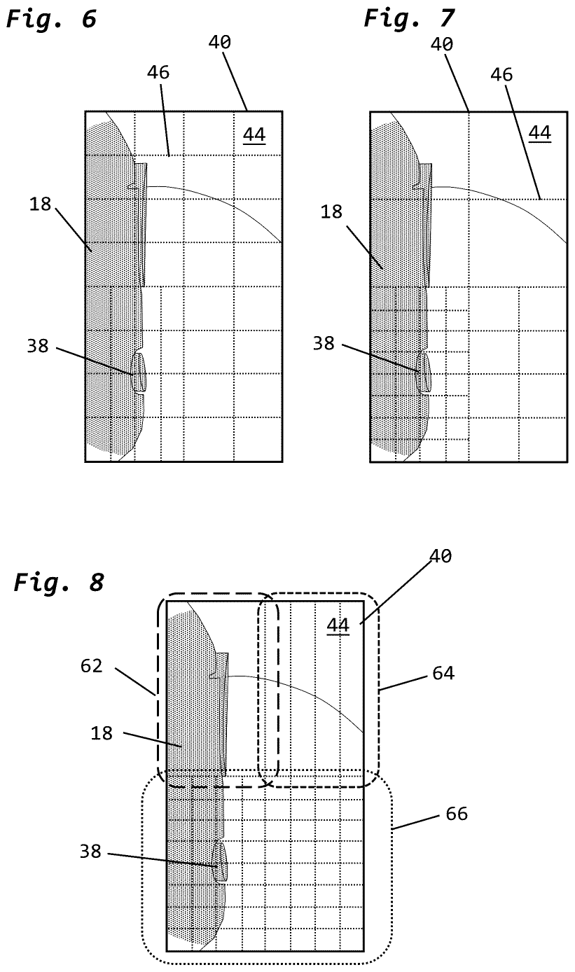

FIG. 6 shows the output image 44 displayed on the sensor surface 40, which is divided into output image areas by means of the output grid 46. The meshes of the output grid 46 have different shapes and sizes. In an upper area and in a right half of the output image 44, the meshes of the output grid 46 have a square shape and are of equal size. In the area of the front wheel 38 of the vehicle 18, however, the meshes have a rectangular shape and are significantly smaller than the other meshes. By specifying smaller meshes, a finer adjustment of the image content can be made. By specifying larger meshes, however, larger image contents can be adjusted in the same way.

FIG. 7 shows the output image 44 displayed on the sensor surface 40, which is divided into output image areas by a further initial grid 46. In the further initial grid 46, the meshes in the upper half of the output image 44 are significantly larger than those in the lower half. In the lower half of the output image 44, the meshes in the area of the front wheel 38 are significantly smaller than those defined in the area to the right of it.

FIG. 8 shows the output image 44 displayed on the sensor surface 40, which is divided into output image areas by another output grid 46. The output grid 46 can be divided into the output grid areas 62, 64, and 66 according to the definition of the meshes. In the first output grid area 62, only one mesh is defined, since only a minor adjustment of the image content, if any, is to be made in this area. In the second output grid area 64, elongated rectangular meshes extend over the entire height of the second output grid area 64. In this way, a change in the shape of the edges over a larger image content can be used to distort or undistort the edges depicted in the image section. In the third output grid area 66, the meshes of the output grid 46 are defined as significantly smaller, so that a stronger and finer-grained adjustment of the image content can be made when transforming the output image 44 into the transformation image 48.

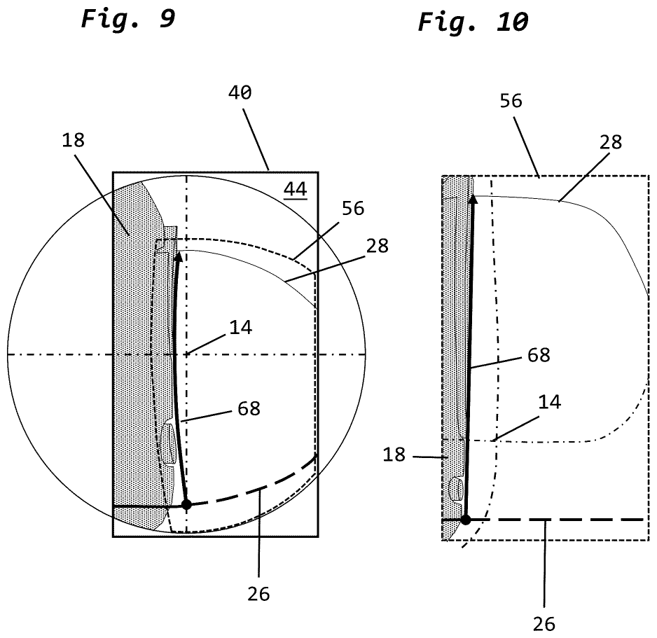

FIG. 9 shows the output image 44 imaged on the image sensor surface 40.

Although the center 14 of the objective 12 is shifted toward the vehicle 18, a lateral lower edge 68 is imaged in a curved manner, for example, due to a large aperture angle of the image acquisition unit 2. Due to a greater distance from the center 14 of the objective 12, the extension 26 of the front edge 24 is displayed with even greater curvature.

The output image 44 shown in FIG. 9 is transformed by the processing unit 4 by means of an output grid 46 and a transformation grid 50 into the transformation image 48, a section 56 of which is shown in FIG. 10. It should be noted that the image content displayed by the section 56 is also shown in the representation of the output image 44 in FIG. 9 in order to illustrate the original image. As can be seen in FIG. 10, the transformation grid 50 used is designed such that the lateral lower edge 68 and the extension 26 of the front edge 24 are represented as straight lines in the section 56. Furthermore, the transformation grid 50 is designed such that, in the displayed section 56, the horizon line 28 runs almost horizontally in an area next to the vehicle 18 and is then distorted more strongly downward than is the case in the output image 44.

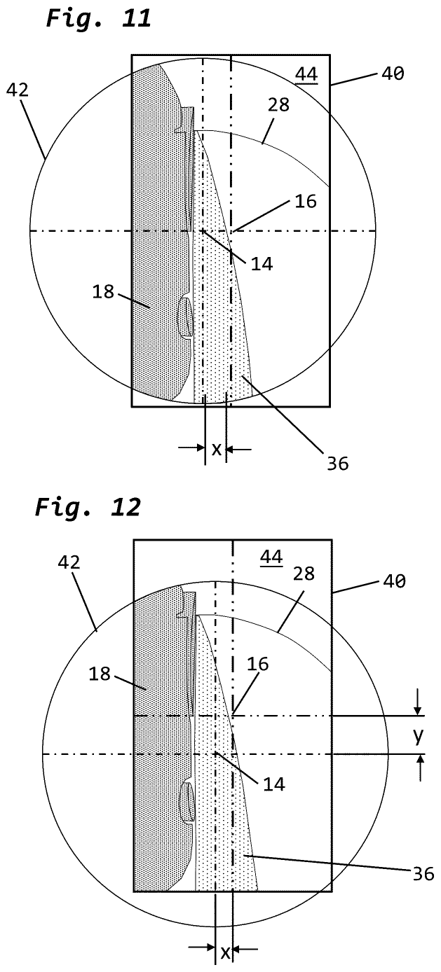

FIG. 11 shows the output image 44 displayed on the image sensor surface 40. Furthermore, the center 14 of the objective 12 and a center 16 of the image sensor 8 are shown. In addition, the area 36 extending from the extension 26 to the horizon line 28 at a distance of 1.5 next to the vehicle 18 is shown. It is to be discerned that the center 14 of the objective 12 is shifted by the distance x in the horizontal direction relative to the center 16 of the image sensor 8 and thus images a point in the area 36, in particular a point on the ground in the area 36. This degree of displacement of the center 14 of the objective 12 toward the vehicle 18 results in the lateral lower edge 68 (see FIG. 9), which is used as a vehicle reference, being displayed with less distortion than would be the case if the centers 14 and 16 were superimposed.

FIG. 12 shows the example shown in FIG. 11, wherein the center 14 of the objective 12 is additionally shifted by the distance y in the vertical direction relative to the center 16 of the image sensor 8. The center 14 continues to represent a point in the area 36, in particular a point at the bottom of the area 36.

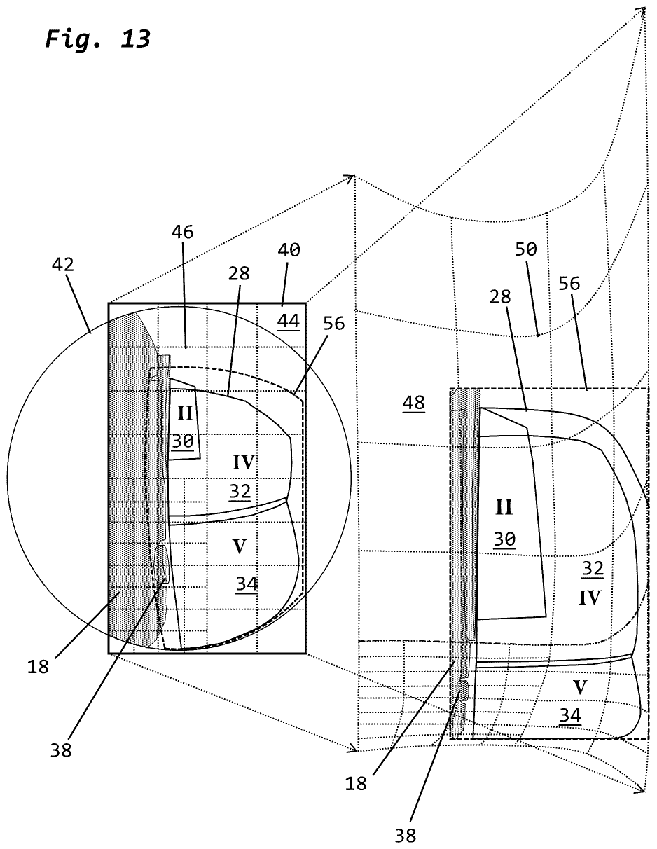

On the left, FIG. 13 shows the output image 44 captured on the image sensor surface 40, which is divided into output image areas of different sizes by the output grid 46. In addition, the field of view II 30, the field of view IV 32, and the field of view V 34 according to UN/ECE-R46 are shown. The output image 44 is transformed by the processing unit 44 into the transformation image 48, a section 56 of which is displayed on the display unit 6. Through transformation, the field of view II 30, the field of view IV 32, and the field of view 34 V are adjusted so that they are displayed on the display unit 6 in accordance with the respective legal requirements of UN/ECE-R46. In particular, the field of view II 30 is displayed with virtually no distortion. Field of view IV 32 is stretched primarily in height. However, towards an outer edge of the displayed section 56, field of view IV 32 is significantly distorted. The field of view V 34 is significantly compressed in height and strongly distorted in the area of the front wheel 38. As a result, the field of view II 30, the field of view IV 32, and the field of view V 34 can be displayed without any transition on the display unit 6 in accordance with their respective legal requirements.

### LIST OF REFERENCE SYMBOLS

1 Indirect vision system
2 Image acquisition unit
4 Processing unit
6 Display unit
8 Image sensor
10 Holding device
12 Objective
14 Center of the objective
16 Center of the image sensor
18 Vehicle
20 Tractor unit
22 Trailer
24 Front edge
26 Lateral extension of the front edge
28 Horizon line
30 Field of view II
32 Field of view IV
34 Field of view V
36 Area next to the vehicle
38 Front wheel of the vehicle
40 Image sensor surface
42 Objective surface
44 Output image
46 Output grid
48 Transformation image
50 Transformation grid
52 Output image area
54 Transformation image area
56 Displayed section of the transformation image
58 Transformation image areas
60 Image content
62 First output grid portion
64 Second output grid portion
66 Third output grid portion
68 Lateral lower edge
x Distance in horizontal direction
y Distance in vertical direction

1. An indirect vision system for a vehicle, wherein the indirect vision system comprises:
an image acquisition unit comprising a single image sensor and an objective that is designed and is mounted or is configured to be mounted on the vehicle in such a way that a plurality of predetermined areas in a vicinity of the vehicle can be captured by the image sensor in an output image, wherein the objective and the image sensor are arranged relative to each other such that a center of the objective and a center of the image sensor are offset relative to each other,
a processing unit which is designed to transform the output image into a transformation image, and
a display unit which is designed to display at least one section of the transformation image,
wherein
the processing unit is designed to divide the output image at least partially into output image areas according to an output grid and to transform the output image areas into transformation image areas defined by a transformation grid, wherein the transformation grid is designed such that the predetermined areas can be displayed in the section of the transformation image displayed on the display unit in accordance with a respective specification.

2. The indirect vision system according to claim 1, wherein
the output grid and the transformation grid have edges and nodes corresponding to each other that function as support points for the output image areas and the transformation image areas, respectively,
in the transformation grid, some of the edges and/or nodes are modified relative to the output grid, and
the processing unit is designed to transform the output image areas supported by the edges and/or nodes changed in the transformation grid compared to the output grid into the transformation image areas by means of interpolation.

3. The indirect vision system according to claim 2, wherein
a course and/or position of the edges and/or the position of the nodes in the transformation grid is changed relative to the output grid.

4. The indirect vision system according to claim 1, wherein
the processing unit is designed to adapt the output grid and/or the transformation grid.

5. The indirect vision system according to claim 4, wherein
the processing unit is designed to adjust the output grid and/or the transformation grid during automatic or manual adjustment of the section of the transformation image displayed on the display unit and/or during a view change on the display unit.

6. The indirect vision system according to claim 1, wherein
the center of the objective is offset in a direction of the vehicle relative to the center of the image sensor.

7. The indirect vision system according to claim 6, wherein
the center of the objective images a point that lies within a distance of up to 1.5 m to one side of the vehicle.

8. The indirect vision system according to claim 1, wherein
the transformation grid is designed such that an edge of the vehicle used as a vehicle reference is represented in the transformation image as a substantially straight line.

9. The indirect vision system according to claim 1, wherein
the transformation grid is designed such that a lateral extension of a front edge of the vehicle is represented as a straight line in the transformation image.

10. The indirect vision system according to claim 1, wherein
the plurality of areas comprise at least one area which extends from a front edge of the vehicle to a horizon located behind the vehicle at a predetermined distance next to the vehicle, and
this area is completely contained within the section of the transformation image displayed on the display unit.

11. The indirect vision system according to claim 10, wherein
the vehicle comprises a trailer, and
the section of the transformation image displayed on the display unit includes a front upper corner of the trailer.

12. The indirect vision system according to claim 1, wherein
the plurality of areas comprise the legal fields of view II and IV in accordance with UN/ECE-R46, and
the transformation grid is designed such that the legal fields of view II and IV according to UN/ECE-R46 can be displayed on the display unit in accordance with a respective legal requirement.

13. The indirect vision system according to claim 1, wherein
the edges and nodes of the output grid are arranged such that the output grid forms meshes with different sizes and/or shapes.

14. The indirect vision system according to claim 13, wherein
the size and/or shape of the meshes of the output grid is determined according to a strength of the transformation to be performed on the output image into the transformation image.

15. A vehicle comprising the indirect vision system according to claim 1.
